(19) United States
(12) Patent Application Publication
(10) Pub. No.: US 2006/0006754 A1
(43) Pub. Date: Jan. 12, 2006

(54) D.C. brushless motor

(75) Inventor: John M. Calico, Marietta, GA (US)

Correspondence Address: PHILLIPS LYTLE LLP;INTELLECTUAL PROPERTY GROUP, 3400 HSBC CENTER, BUFFALO, NY, 14203-3509, US

(73) Assignee: Moog Components Group Inc.

(21) Appl. No.: 11/222,305

(22) Filed: Sep. 8, 2005

Related U.S. Application Data
(63) Continuation of application No. 10/610,747, filed on Jul. 1, 2003, now abandoned.

(51) Int. Cl. B22F 7/00; H02K 1/27

(52) U.S. Cl. 310/156.43; 29/598; 310/43; 419/5

(57) ABSTRACT

A permanent magnet rotor for a dc brushless motor generally comprised of a non-insulated shaft and and a permanent magnet is formed in one embodiment by compacting a powdered permanent magnet material substantially about a non-insulated shaft of relatively incompressible material utilizing dynamic magnetic compaction (DMC) techniques. In other embodiements, the rotor is comprised of a non-insulated shaft, a magnetic core and a permanent magnet and is formed by first compacting a powdered core material substantially about the non-insulated shaft of relatively incompressible material to form a magnetic core and then compacting a powdered permanent magnet material substantially about the core to form a permanent magnet, with the compaction of the powdered materials occurring by DMC. Other embodiments may be formed by simultaneously compacting a powdered core material and a powdered permanent magnet material about a non-insulated shaft of relatively incompressible material utilizing DMC techniques.

### BACKGROUND OF THE INVENTION

1. Field of the Invention

The invention pertains to rotors for electric motors. It specifically pertains to permanent magnet rotors formed by dynamic magnetic compaction for brushless dc motors.

2. Description of Related Art

Generally, a brushless dc motor has a rotor comprised of a shaft, a magnetic return path and a permanent magnet. A brushless dc motor also has a stator comprised of electrical windings (usually insulated copper windings) that are wound on or embedded into a core material such that once the windings are energized, a magnetic field is formed that interacts with the magnetic field of the permanent magnet of the rotor in a manner such that torque and subsequent rotation is produced in the rotor. In some instances, the permanent magnet of the rotor may be a ring of magnetic material that encompasses a core material with the core material surrounding the shaft of the rotor. Permanent magnet rotors of this type are generally formed by producing a cylindrical core ring and a cylindrical, hollow permanent magnet ring wherein the inside diameter of the magnetic ring is just slightly larger than the outer diameter of the core material. The magnetic ring is placed over the core and affixed, and the core is placed over and affixed to a shaft.

Various electrical components such as rotors and stators have been formed using dynamic magnetic compaction (DMC). Dynamic magnetic compaction generally involves metallic powders that are placed into a conductive container. The conductive container is then placed within an electrical coil or otherwise exposed to a magnetic field that is created by an electrical current passing through a conductor. A large current is pulsed through the electrical coil thus creating a very strong magnetic field. This magnetic field will collapse the conductive container and compact the metallic powders into a solid object. U.S. Pat. Nos. 5,405,574; 5,611,139; 5,611,230; 5,689,797; 6,273,963 and 6,432,554 (all assigned to LAP Research, Inc.), each fully incorporated herein and made a part hereof, disclose methods of dynamic magnetic compaction and are related to the formation of electrical components. DMC allows the formation of components of various shapes. DMC also reduces production time as electrical windings may be incorporated into a component during the formation process. Furthermore, DMC produced components may have magnetic flux densities greater than that of components produced by other means because of the ability of the DMC process to compact the material to nearly full density.

For example, U.S. Pat. No. 5,405,574, “Method for Compaction of Powder-Like Materials,” was issued to Chelluri et al. on Apr. 11, 1995 from an application filed on Feb. 10, 1992 and is assigned to IAP Research, Inc. This patent is generally directed toward the DMC process and describes methods of producing a wire-like electrically conductive body comprising dense highly compacted particulate material, methods of producing an electrically conductive member, and methods of producing highly dense body superconductive materials.

U.S. Pat. No. 5,611,139, “Structure and Method for Compaction of Powder-Like Material,” issued to Chelluri et al. on Mar. 18, 1997 from an application filed on Apr. 6, 1995 as a continuation-in-part of an application filed Feb. 10, 1992 that issued as U.S. Pat. No. 5,405,574. This patent is assigned to IAP Research, Inc. It is directed toward structures and devices that utilize dynamic magnetic compaction of powdered material to form high-density bodies of varying shapes and sizes such as rods, tapes, tubes, plates, wheels, etc.

U.S. Pat. No. 5,611,230, “Structure and Method for Compaction of Powder-Like Material,” issued to Chelluri et al. on Mar. 18, 1997 from an application filed on Jan. 3, 1995 as a division of an application filed Feb. 10, 1992 that issued as U.S. Pat. No. 5,405,574. This patent is assigned to LAP Research, Inc. This patent is generally directed toward the DMC process and again describes a system for producing a body of dense highly compacted particulate material.

U.S. Pat. No. 5,689,797, “Structure and Method for Compaction of Powder-Like Materials,” issued on Nov. 18, 1997 to Chelluri et al. from an application filed Apr. 6, 1995 as a continuation-in-part of an application filed Feb. 10, 1992 that issued as U.S. Pat. No. 5,405,574. This patent is assigned to IAP Research, Inc. This patent is also generally directed toward DMC and producing bodies, including annular bodies, from powdered materials through DMC.

U.S. Pat. No. 6,273,963, “Structure and Method for Compaction of Powder-Like Materials,” issued on Aug. 14, 2001 to Barber from an application filed on Jul. 29, 1996 as a continuation-in-part of an application filed on Jan. 3, 1995, now U.S. Pat. No. 5,611,230. A divisional application claiming priority upon this patent has also been filed and was published on Dec. 13, 2001 as U.S. Patent Application Publication No. 2001/0051104. Both the patent and the published application are assigned to IAP Research, Inc. The patent and the published application disclose “over-pressuring” a powdered material through DMC to densify the material to over 90 percent of its maximum density.

U.S. Pat. No. 6,156,264, “Electromagnetic Compacting of Powder Metal for Ignition Core Application,” issued to Johnston et al. on Dec. 5, 2000 from an application filed on Oct. 6, 1999. It is assigned to Delphi Technologies, Inc. and is fully incorporated herein and made a part hereof. The patent generally discloses a process for producing a cylindrical electromagnetic core by exposing powdered metals to an electromagnetic field. Among the parts fabricated according to this patent are AC cylindrical electromagnetic parts, such as AC cylindrical electromagnetic ignition coil cores.

U.S. Pat. No. 6,432,554, “Apparatus and Method for Making an Electrical Component,” issued to Barber et al. on Aug. 13, 2002 from an application filed on Feb. 15, 2000 as a continuation-in-part of an application filed on Jul. 29, 1996, now issued as U.S. Pat. No. 6,273,963. A continuation application has also been filed that was published on Aug. 12, 2002 as U.S. Patent Application Publication No. 2002/0192103. The patent and published application are assigned to LAP Research, Inc. This patent and published application disclose systems and methods wherein powdered materials are placed in a conductive container along with an electrically insulated coil and subjected to DMC to produce a component part, such as a transformer, choke, rotor or stator for an electric motor and the like, with an embedded electrically insulated coil.

U.S. Pat. No. 6,232,681, “Electromagnetic Device with Embedded Windings and Method for its Manufacture,” issued on May 15, 2001 to Johnston et al. from an application filed on Mar. 23, 2000. A divisional application claiming priority upon this patent has also been filed and was published on Jan. 17, 2002 as U.S. Patent Application Publication No. 2002/0005675. The patent and published application are assigned to Delco Remy International, Inc. The patent is incorporated herein and made a part hereof. The patent and published application disclose a stator core with embedded stator windings manufactured using DMC with radial compaction techniques. The patent and published application also describes a method of fabricating an electromagnetic device, such as a stator, with embedded windings.

U.S. Pat. No. 6,362,544, “Electromagnetic Device with Embedded Windings and Method for Manufacture,” issued to Johnston et al. on Mar. 26, 2002 from an application filed on Apr. 30, 2001 as a continuation of an application filed on Mar. 23, 2002, now issued as U.S. Pat. No. 6,232,681. It is assigned to Delco Remy International, Inc. and is fully incorporated herein and made a part hereof. It describes a cylindrical electromagnetic device with embedded insulated windings comprised of radially compacted powdered magnetic materials.

Other prior art references related to DMC include United States Patent Application Publication No. 2002/0036367, “Method for Producing & Manufacturing Density Enhanced, DMC, Bonded Permanent Magnets,” filed by Walmer et al. on Feb. 13, 2001 as a non-provisional application of a provisional application filed on Feb. 22, 2000. In addition, United States Patent Application Publication No. 2002/0043301, “Density Enhanced DMC, Bonded Permanent Magnets,” filed by Walmer et al. on Feb. 13, 2001 as a non-provisional application of a provisional application filed on Feb. 22, 2000. Both applications were published on Apr. 18, 2002. Each application discloses a DMC method for producing stable, denser, bonded permanent magnets where the binder is inorganic or organic with up to about a 40 percent increase in magnetic saturation performance over magnets formed by traditional methods.

United States Patent Application Publication No. 2002/0117907, “Electromagnetic Pressing of Powder Iron for Stator Core Applications,” filed Feb. 27, 2001 by Gay et al. It was published on Aug. 29, 2002. It discloses a stator core for an electric motor made of compacted powder material with each particle electrically insulated from one another. For example, the published application describes a stator core to have a density of 98 percent of its theoretical density. The published application also describes methods of manufacturing such a stator core.

As shown above, many electromagnetic devices formed by DMC and methods of forming such devices through DMC are disclosed in the prior art. Specifically, most of the prior art discloses the use of DMC to form electromagnetic parts containing embedded insulated windings such as stators, rotors (not dc brushless motor rotors), inductors and transformers. The prior art referenced above disclose stators or rotors with embedded electrically insulated windings or shapes formed of magnetic material through the DMC process; however, what is needed is a rotor for a brushless dc motor formed by dynamic magnetic compaction techniques.

### BRIEF SUMMARY OF THE INVENTION

Therefore, the permanent magnet rotor of the present invention may be used in a brushless dc motor and is formed by DMC, but does not include embedded windings for use in a brushless dc motor. Furthermore, an efficient manufacturing process is disclosed for producing the DMC rotor by forming the core of the rotor by either compacting the powdered core material directly onto the non-insulated shaft of the rotor and then compacting the powdered permanent magnet material onto the core material, or simultaneously compacting the powdered core and permanent magnet material onto the non-insulated shaft rather than separately manufacturing the components and then assembling them onto a shaft. The powdered material that forms the rotor is compacted in such a way as to engage or be affixed to the embedded member (shaft), as contrasted to conventional techniques such as those described in U.S. Pat. Nos. 6,432,554 and 6,273,963, that require special procedures to be taken in order to protect the embedded windings from the compacted metallic material during the compaction process. U.S. Pat. No. 6,432,554 discloses a rotor formed through DMC; however it fails to disclose a rotor formed through the compaction of a powdered permanent magnet material to form a permanent magnet simultaneously with a soft iron powdered core material to form a core, together forming a rotor. Therefore, one aspect of the present invention is a rotor for a dc brushless motor formed through DMC techniques. Another aspect of the present invention is methods of forming such rotor by either simultaneously compacting the permanent magnet material and the powdered core onto a non-insulated shaft, or compacting the core material onto the shaft and then compacting the permanent magnet material onto the core material.

The permanent magnet of the present invention is a ring magnet that substantially overlays the core material in a radially outward direction from the core material. The core is attached to the rotor's shaft along a portion of the axial length of the shaft and extends radially outward from the shaft. By utilizing DMC to simultaneously compact onto a shaft more than one type of metallic powder material to form the permanent ring magnet and the core for the rotor or forming the rotor by compacting the core material onto the shaft and then compacting the permanent magnet material onto the core material or by using DMC to compact the permanent magnet material onto a core that is about the shaft, the fabrication process is facilitated. Furthermore, the shaft of the rotor is a non-insulated member as contrasted to the insulated embedded windings of conventional designs, merely simplifying the fabrication process.

Embodiments of the present invention utilize materials such as isotropic neodymium powder, anisotropic neodymium and exchange spring nano-powder neodymium, as well as others, in forming the permanent magnet. The core is generally formed of soft iron powders. Rotors formed through magnetic compaction techniques generally have a higher flux density than rotors formed through traditional manufacturing techniques.

Various embodiments of this invention include methods and systems for: Simultaneous compaction of permanent magnet and core powdered materials onto a non-insulated member (shaft) to form a rotor for an electric motor; forming a rotor for an electric motor by first compacting a powdered core material onto a non-insulated member and then compacting a powdered permanent magnet material onto the core; and forming a rotor by compacting permanent magnet material onto a non-insulated member.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1A is an exploded view of an exemplary dc brushless electric motor with a DMC rotor and a wound laminated stator in an embodiment of the invention;

FIG. 1B is an exploded view of an exemplary dc brushless electric motor with a DMC rotor and a DMC produced stator in an embodiment of the invention;

FIG. 2A is an exemplary cross-sectional illustration of a permanent magnet rotor with a magnetic core formed by DMC in an embodiment of the invention;

FIG. 2B is an exemplary cross-sectional illustration of a permanent magnet rotor without a magnetic core formed by DMC in an embodiment of the invention;

FIG. 3A is an exemplary cross-sectional view of an apparatus for forming the permanent magnet rotor of the present invention by DMC by compacting a powdered permanent magnet material substantially about a magnetic core that was previously formed by compacting a powdered core material substantially about a non-insulated shaft of relatively incompressible material in an embodiment of the invention;

FIG. 3B is an exemplary cross-sectional view of an apparatus for forming the permanent magnet rotor of the present invention by DMC by compacting a powdered permanent magnet material substantially about a magnetic core that was previously formed by compacting a powdered core material substantially about a non-insulated shaft of relatively incompressible material to form various layers of the core in an embodiment of the invention;

FIG. 4A is an exemplary cross-sectional view of an apparatus for forming the permanent magnet rotor of the present invention by DMC by simultaneously compacting a powdered permanent magnet material and a powdered core material substantially about a non-insulated shaft of relatively incompressible material to form a magnetic core and a permanent magnet in an embodiment of the invention;

FIG. 4B is an exemplary cross-sectional view of an apparatus for forming the permanent magnet rotor of the present invention by DMC by compacting a powdered permanent magnet material substantially about a non-insulated shaft of relatively incompressible material to form a permanent magnet in an embodiment of the invention;

FIG. 4C is an exemplary cross-sectional view of an apparatus for forming the permanent magnet rotor of the present invention by DMC by compacting various layers of a powdered permanent magnet material and a powdered core material substantially about a non-insulated shaft of relatively incompressible material to form various layers of the core and the permanent magnet where such layers may be compacted simultaneously or sequentially, beginning with the layer nearest the shaft, in an embodiment of the invention;

FIG. 5 is an exemplary flowchart for the process of producing the permanent magnet rotor of the invention by DMC techniques in an embodiment of the invention;

FIG. 6A is an exemplary plot of the back EMF produced by a permanent magnet rotor of an embodiment of the invention, the magnetic core and the permanent magnet of this rotor produced by DMC techniques;

FIG. 6B is an exemplary plot of the back EMF produced by a permanent magnet rotor, the magnetic core is formed of machined bar stock and the permanent magnet of this rotor is produced by compression molding techniques, the performance of this rotor is to be compared with the performance of the rotor illustrated in FIG. 6A;

FIG. 6C is an exemplary plot of the back EMF produced by a permanent magnet rotor, the magnetic core and the permanent magnet of this rotor produced by compression molding techniques, the performance of this rotor is to be compared with the performance of the rotor illustrated in FIG. 6A;

FIG. 7A is an exemplary plot of the back EMF produced by a permanent magnet rotor of an embodiment of the invention, the magnetic core and the permanent magnet of this rotor produced by DMC techniques and the permanent magnet formed of exchange spring nano-powder neodymium; and

FIG. 7B is an exemplary plot of the back EMF produced by a permanent magnet rotor, the magnetic core is formed of machined bar stock and the permanent magnet of this rotor is produced by compression molding, the performance of this rotor is to be compared with the performance of the rotor illustrated in FIG. 7A.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

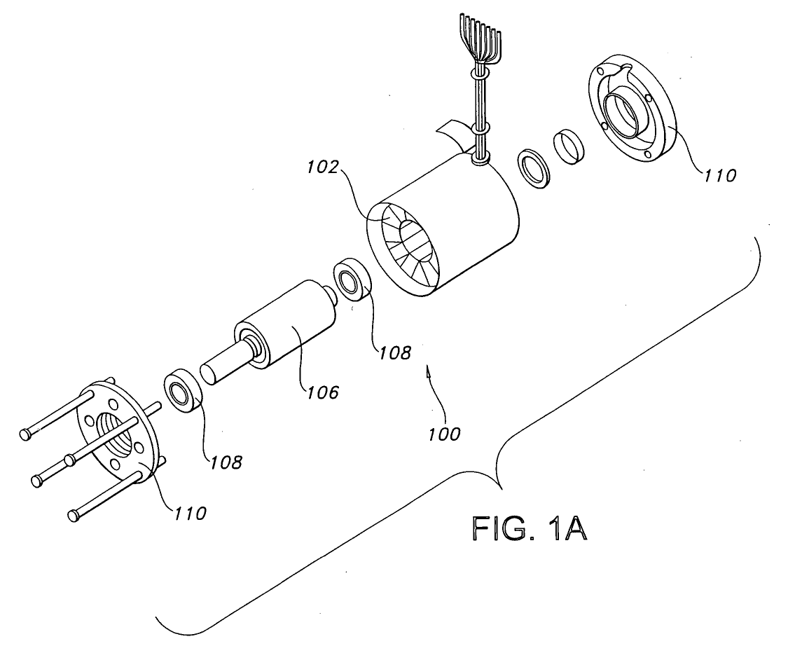

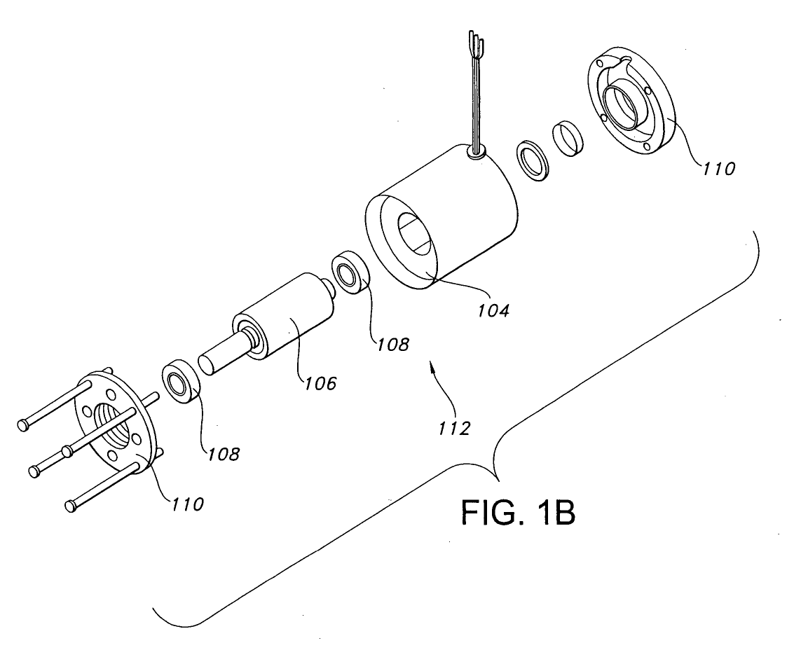

A brushless dc motor 100, 112 such as that shown in FIGS. 1A and 1B is comprised of a stator member 102, 104 and a rotor member 106 that are joined by a bearing 108 and end plate 110 system. FIG. 1A is an exploded view of an exemplary dc brushless electric motor 100 with a DMC rotor member 106 and a traditional wound laminated stator 102 in an embodiment of the invention. FIG. 1B is an exploded view of an exemplary dc brushless electric motor 112 with a DMC rotor member 106 and a DMC produced stator member 104 in another embodiment of the invention.

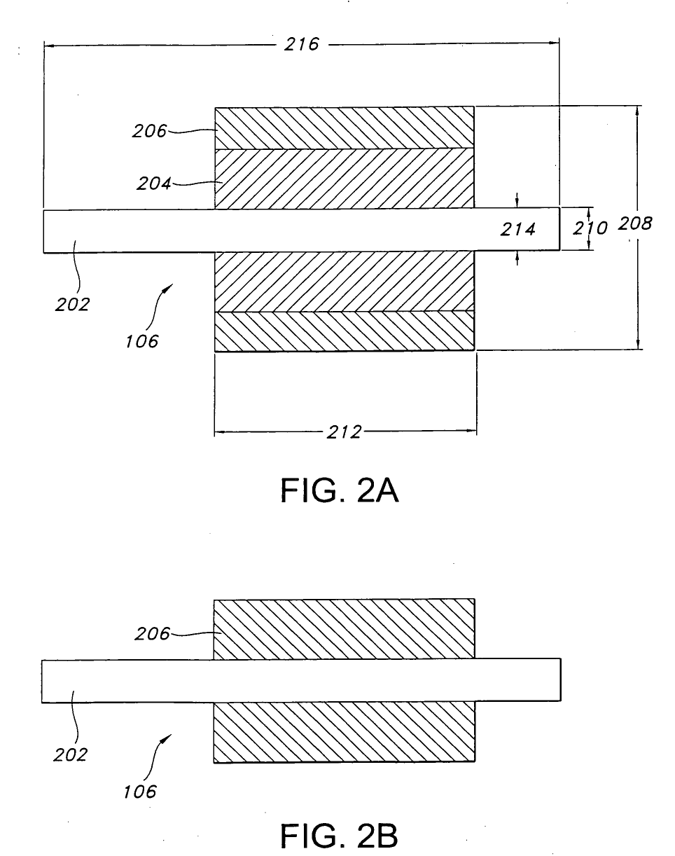

FIGS. 2A and 2B are exemplary cross-sectional illustrations of a permanent magnet rotor formed by DMC in an embodiment of the invention. As shown in more detail in FIG. 2A, a typical embodiment of the rotor member 106 is comprised of a shaft 202, magnetic core 204 and permanent magnet 206, although the magnetic core 204 is not required to practice this invention, as is illustrated in the rotor 106 of FIG. 2B. The permanent magnet 206 and the core 204 (if utilized), generally combine to form a cylindrical shape, having an outer diameter 208, an inner diameter 210 and an axial length 212. The shaft 202 is generally comprised of a solid material, also in a cylindrical shape, having an outer diameter 214 and an axial length 216. The axial length 216 of the shaft 202 is generally greater than that of the cylindrical permanent magnet 206 and core 204 assembly so that bearings 108 and end plates 110 may be affixed to the shaft 202 for mounting the rotor 106 within the stator member 102, 104 and so that the shaft 202 may be externally connected to some device in order to perform work.

The stator 102 of a brushless dc motor 100 is typically comprised of iron laminations, insulated copper conductors, leads and insulation components as shown in FIG. 1A, though a stator 104 may also be produced by DMC as shown in FIG. 1B. The iron laminations are usually insulated to reduce eddy-current losses. The thin, iron larminations are “stacked” to form a conventional stator in a shape having a hollow, cylindrical void through its center. The inner circumference of the hollow cylinder generally has “teeth” about which insulated electrical windings are wrapped in such a manner to form a magnetic field in the teeth that simulates rotation about the interior of the stator. The inner diameter of the stator is just slightly larger than the outside diameter of the rotor 106, such that an air gap exists between the rotor 106 and the stator 102, 104. The magnetic field of the stator interacts with the magnetic field of the rotor such that the rotor turns within the stator. Embodiments of the present invention include a rotor member 106 produced by DMC that may be used in a brushless dc motor, while other aspects of the present invention are directed to methods of producing such a rotor 106. The embodiments of the invention provide improved performance and reduced fabrication costs over traditional techniques.

The process of dynamic magnetic compaction has been described by U.S. Pat. No. 6,273,963, and other patents previously incorporated herein. In the embodiments of this invention however, a rotor member 106, 218 is produced by DMC techniques. The rotor 106, 218 may be used in dc brushless motors 100, 112 with conventional stator members 102 or with stator members 104 that are also produced by DMC techniques.

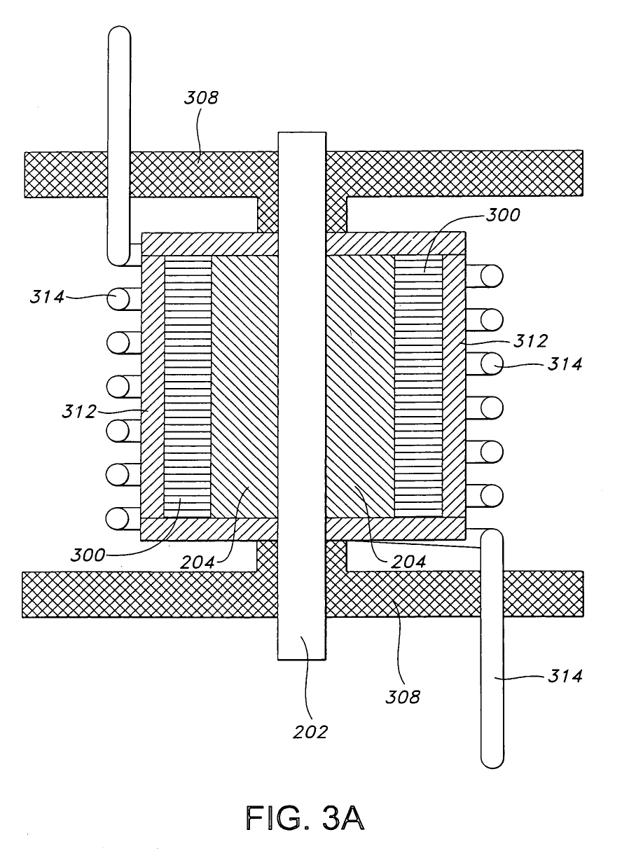

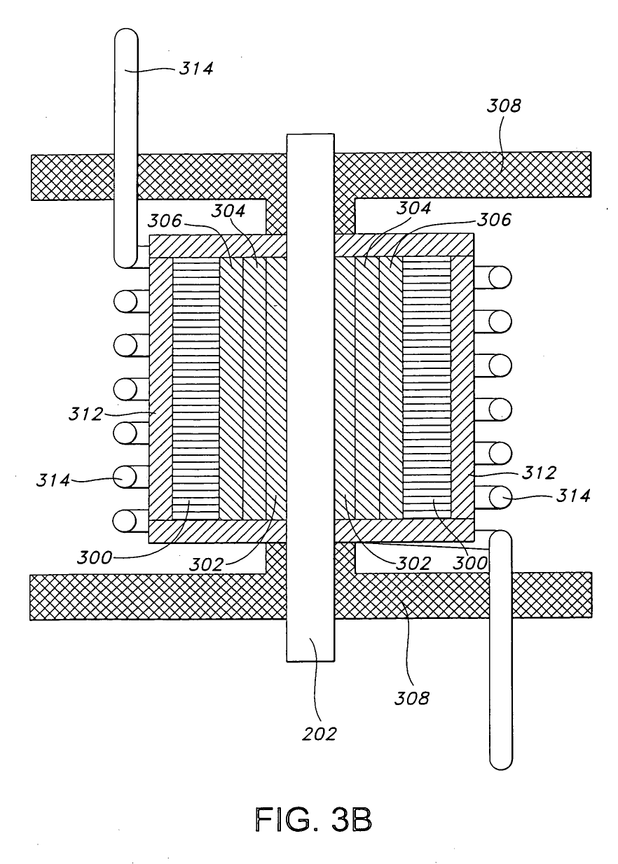

FIG. 3A is an exemplary illustration of an apparatus for the compaction of a powdered permanent magnet material 300 substantially about a previously compacted core 204 in an embodiment of the invention. As shown in FIG. 3A, the rotor 106 may be produced by compacting powdered permanent magnet material 300 by DMC substantially about the radial exterior area of a cylindrical magnetic core 204 having an axial length. The core 204 of this embodiment has, in turn, previously been powdered core material compacted by DMC substantially about a cylindrical non-insulated member 202 with the cylindrical non-insulated member 202 having an axial length greater than the axial length of the core 204, although in other embodiments the core 204 may be comprised of a solid material or layers of material (not shown). The cylindrical non-insulated member forms the shaft 202 of the rotor 106 and is comprised of a relatively incompressible material as compared to the powdered core and permanent magnet material. For example, the shaft 202 may be formed of a material such as stainless steel. The stainless steel that forms such a shaft will not be in the form of a powdered material but will be in the form of a solid such that it will not be further compressed, or will only be minutely compressed by the dynamic magnetic compaction process. The shaft 202 may have a relatively smooth outer area or portions of the outer area may be scored, knurled, ridged, keyed or otherwise striated to better enable friction adhesion between the compacted powdered material and the shaft 202. As shown in FIG. 3B, the powdered core material may be sequentially compacted onto the shaft 202 in one or more layers 302, 304, 306 to form the core 204. Each layer may be of the same or different thickness and of the same or different materials.

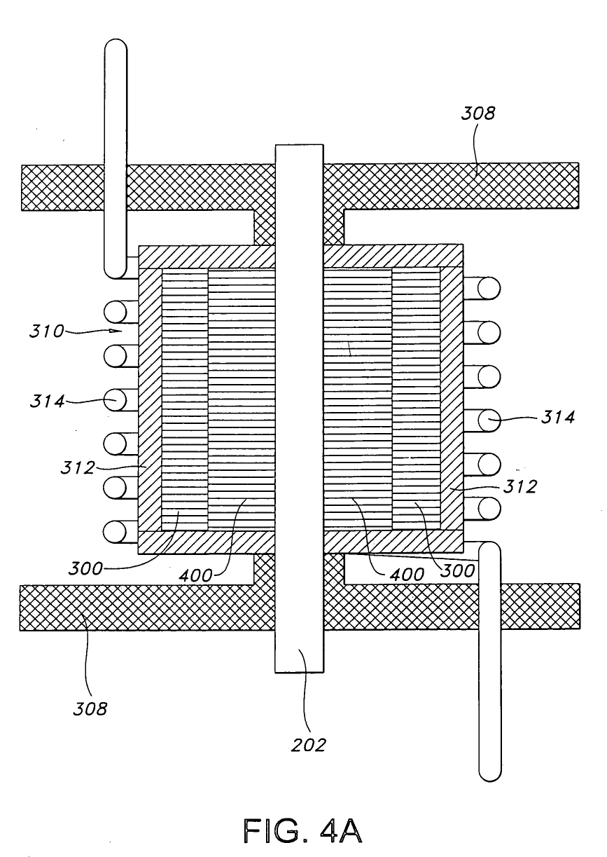

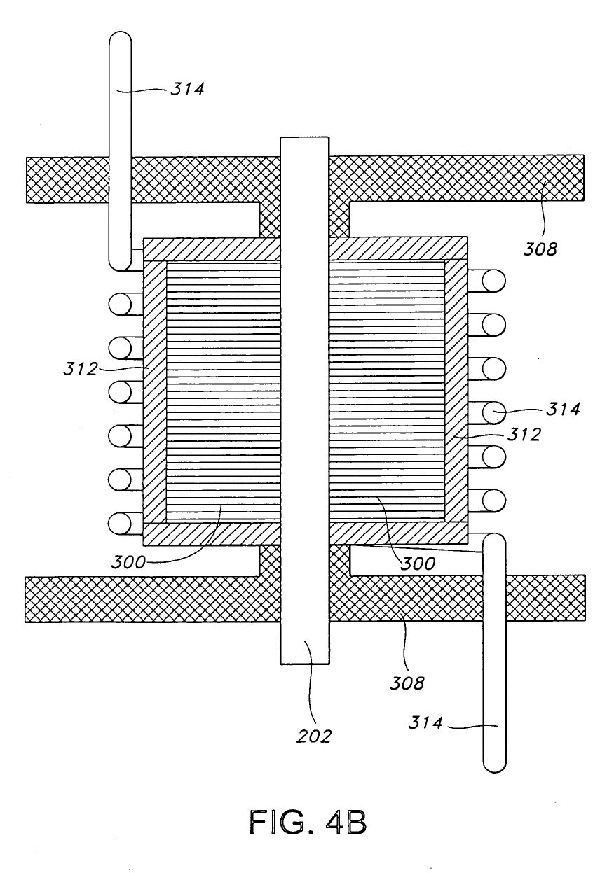

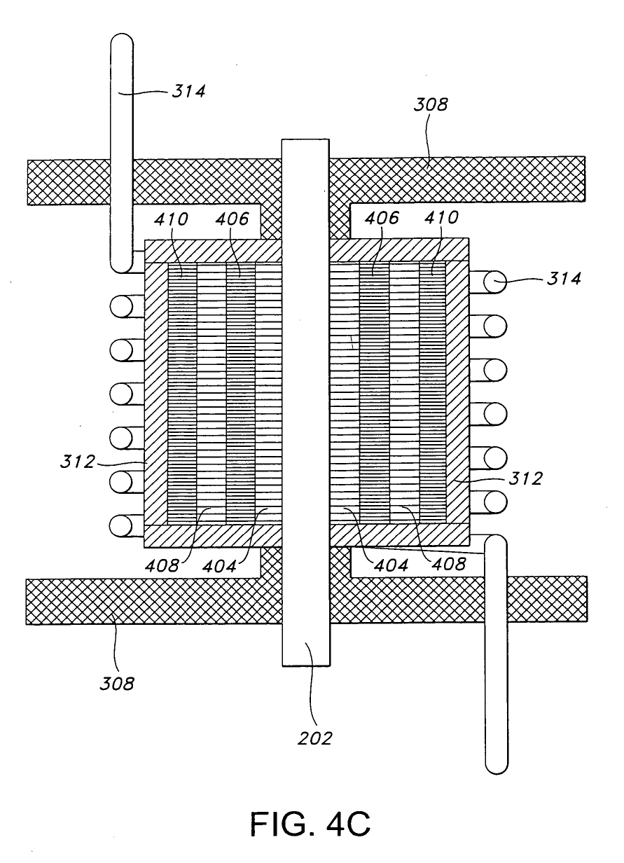

In other embodiments and as shown in FIG. 4A, the rotor 106 may be formed by simultaneously compacting by DMC one or more separate and distinct powdered materials 400, 300 substantially about the exterior radial area of the shaft 202 for a portion of its axial length. In one instance when forming a rotor 106 and as shown in FIG. 4B, only a powdered permanent magnet material 300 may be compacted by DMC directly onto and substantially about a portion of the axial length of the shaft 202. In other instances, referring back to FIG. 4A, a powdered core material 400 and the powdered permanent magnet material 300 may be simultaneously compacted by DMC substantially about a portion of the axial length of the shaft 202. In yet other instances as shown in FIG. 4C, various layers of powdered materials 404, 406, 408, 410 are compacted using DMC substantially about a portion of the axial length of the shaft 202 to form a rotor 106.

The simultaneous compacting of separate and distinct powders to form a core 204 and permanent magnet 206 substantially about a shaft 202 may result in fewer steps in the manufacturing of a rotor 106 for a dc brushless motor, thus increasing production efficiencies and possibly lowering production costs.

Powdered permanent magnet material 300 that may be used to form the permanent magnet 206 of the rotor 106 by DMC techniques include neodymium-iron-boron powders such as, for example, isotropic neodymium powder, anisotropic neodymium and exchange spring nano-powder neodymium powder, although other types of permanent magnet powders are under development or may be developed and may be used in other embodiments of the invention. These neodymium powdered permanent magnet materials are available from Magnequench, Inc. of Indianapolis, Ind., among other suppliers. The powdered core material 400 is generally a soft iron material such as, for example, soft magnetic composites (SMC) as are available from Höganäs AB and Quebec Metal Powders, Ltd. of Montreal, Quebec (QMP), and Atomet TM powders available from QMP, although other types of core material may be used.

In producing a rotor 106 using DMC techniques, the non-insulated shaft 202 is securely placed in a die 308 and one or more powdered materials 400, 300 are placed in one or more chambers 310 circumferentially surrounding a portion of the axial length of the shaft 202. The outer walls 312 of the chambers 310 are electrically conductive and are either deformable such that they may crush radially inwardly toward the shaft 202, or are moveable such that they are mechanically able to move radially inwardly. The conductive chamber walls 312 are then exposed to a magnetic field created by a current pulsed through a nearby conductor 314. The magnetic field creates an inwardly radial pressure on the chamber walls 312 thereby compacting the one or more powdered materials 400, 300 contained therein substantially about the shaft 202 and forming a solid from the powdered materials 400, 300. These procedures are more fully explained in the referenced patents previously incorporated herein.

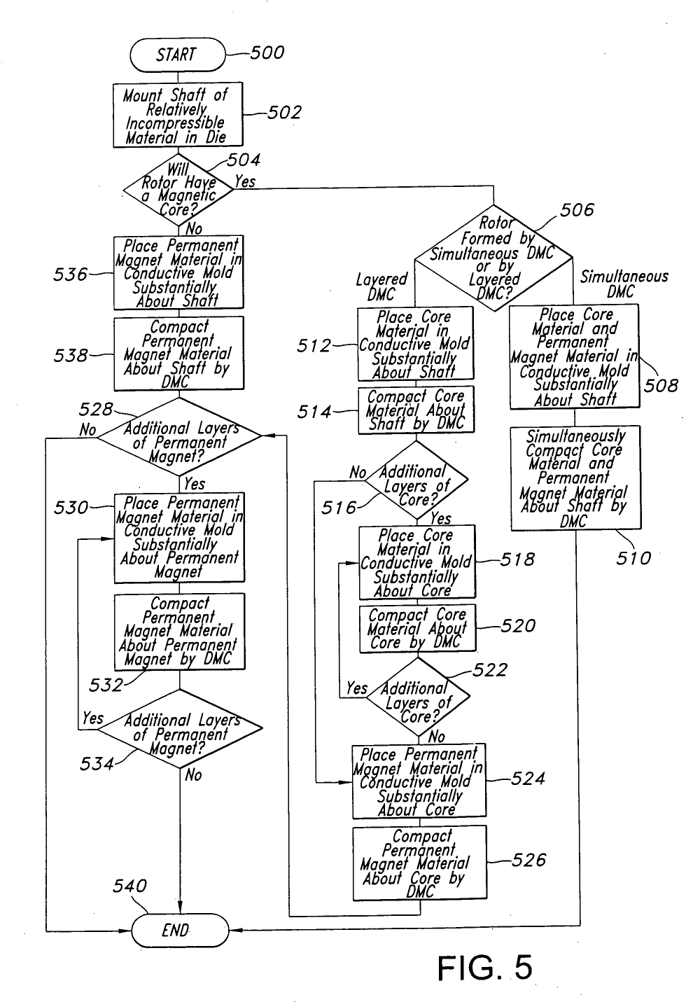

The process of forming the permanent magnet rotor of an embodiment of the invention is more fully described in the flowchart of FIG. 5. The process begins with Step 500. In Step 502, the shaft is mounted in a die to hold it in place during the DMC process. In Step 504, it is determined whether the rotor will have a magnetic core. If the rotor will have a magnetic core, then in Step 506 it is determined whether the rotor will be formed by simultaneous DMC or by layered DMC. If it is determined that the rotor will be formed by simultaneous DMC, then in Step 508 the powdered core material and the powdered permanent magnet material are placed into a mold that has conductive walls that are capable of moving radially inward when exposed to a magnetic field. In Step 510, the powdered core material and the powdered permanent magnet material are simultaneously compacted by DMC substantially about the shaft. The process then ends at Step 540.

If it is determined in Step 506 that the rotor will be formed by layered DMC, then in Step 512 the powdered core material is placed into a mold that has conductive walls that are capable of moving radially inward when exposed to a magnetic field. In Step 514, the powdered core material is compacted by DMC substantially about the shaft. In Step 516, it is determined whether the core will be comprised of additional layers of compacted powdered core material beyond the first layer. If so, then in Step 518 additional core material is placed in the mold substantially about the previously compacted powdered core material and in Step 520, this additional powdered core material is compacted into another layer of core material. These steps are repeated as many times as desired, as indicated by Step 522. If no additional core layers are desired at Step 522, or referring back to Step 516, if it is determined that no additional core layers are desired beyond the first layer of core material, then the process moves to Step 524. In. Step 524, powdered permanent magnet material is placed in the mold substantially about the core. This powdered permanent magnet material is then compacted by DMC to form a permanent magnet substantially about the core in Step 526.

It is then determined in Step 528 whether additional layers of permanent magnet beyond the first layer are desired. If so, then in Step 530 additional powdered permanent magnet material is placed in the mold substantially about the previously compacted powdered permanent magnet material and the additional powdered material is compacted by DMC in Step 532 into another layer of permanent magnet substantially about the previous layer. If additional layers of permanent magnet are desired, then Step 530 and 532 are repeated, as indicated by Step 534. If no additional layers of permanent magnet are desired, then from Step 534 the process moves to Step 540 and ends, or referring back to Step 528, if no additional layers of permanent magnet beyond the first layer are desired, then the process moves from Step 528 to Step 540 and ends.

Referring back to Step 504 where it is determined whether the rotor will have a magnetic core, if the rotor will not have a magnetic core, then the process moves to step 536 where a powdered permanent magnet material is placed in a mold substantially about the shaft and is compacted by DMC in Step 538 substantially about the shaft. Referring again to Step 528, it is then determined whether additional layers of permanent magnet beyond the first layer are desired. If so, then the process goes through the iterative cycle defined by Steps 530, 532, and 534 for as many layers as desired and then the process ends at Step 540. If, at Step 528, it is determined that no additional layers of permanent magnet beyond the first layer are desired, then the process moves to Step 540 and ends.

Once the rotor 106 is formed, in some instances it may require additional machining to meet tolerance requirements and generally, it is sealed with a substance such as, for example, polyurethane, although these additional steps may not be required to practice the invention.

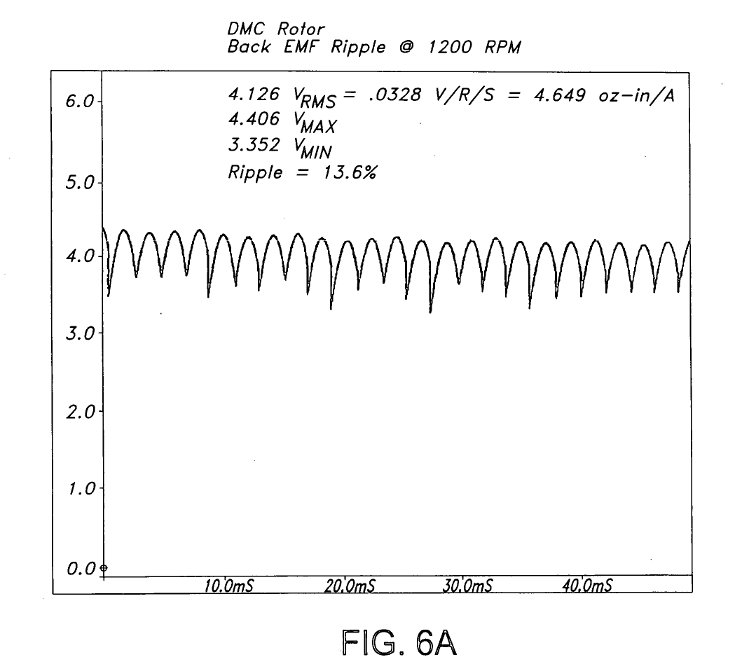

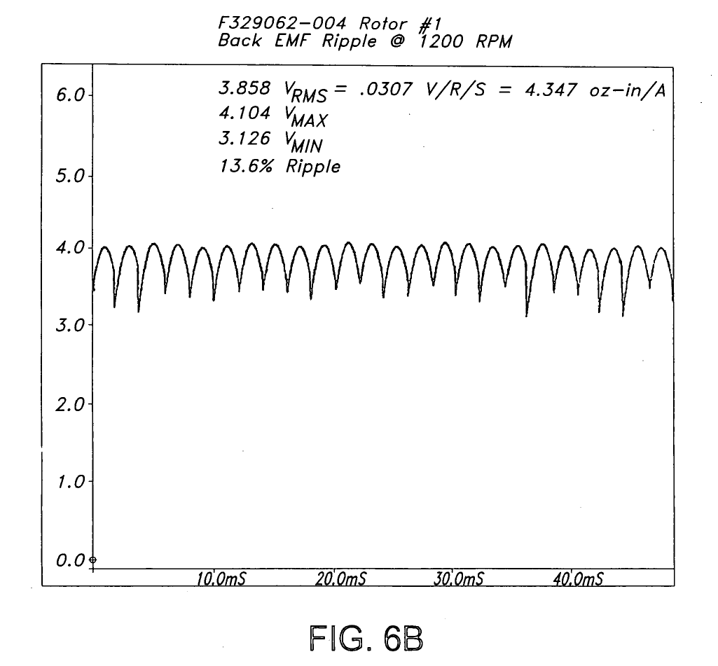

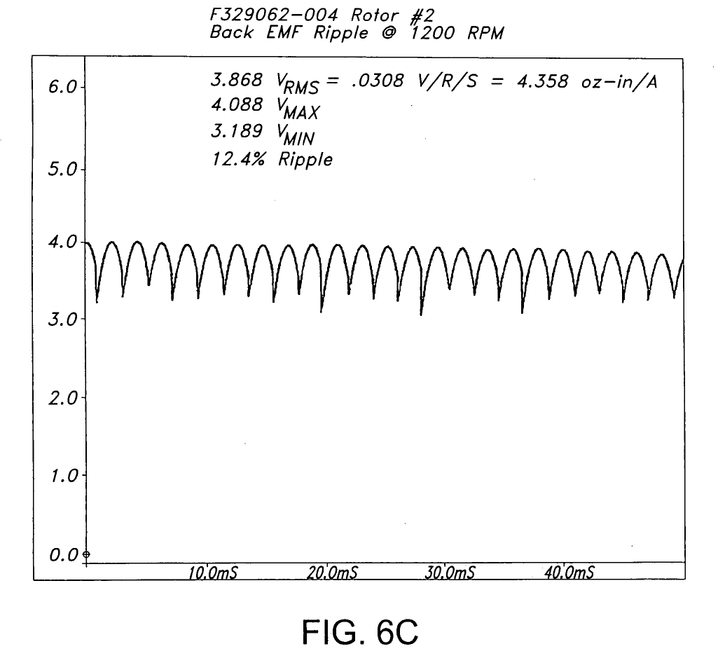

A permanent magnet rotor 106 for a dc brushless motor formed by DMC exhibits increased torque constant over a similar rotor formed by the molding of the same powder materials. Torque constant is directly proportional to a material's flux density. FIGS. 6A, 6B and 6C provide exemplary illustration of the improved performance of a rotor produced by DMC techniques. FIG. 6A is an exemplary plot of the back EMF produced by a rotor of one embodiment of the present invention produced by DMC techniques. FIGS. 6B and 6C are exemplary plots of the back EMF produced by rotors formed of the same materials as the rotor in FIG. 6A, but formed by compression molding techniques, rather than by DMC. FIG. 6A is therefore to be contrasted with FIGS. 6B and 6C, which illustrate the back EMF produced by rotors formed by traditional methods. Each of the rotors tested were of similar design with an outer ring-type permanent magnet over a magnetic core and affixed to a stainless steel shaft, each utilizing isotropic neodymium powders for its permanent magnet. Each of the rotors tested in FIGS. 6A, 6B, and 6C are comprised of permanent magnets formed of isotropic neodymium powder, cores of solid 12L14 steel, and shafts of 416 stainless steel. The results of the tests illustrated in FIGS. 6A, 6B and 6C are summarized in Table 1.

TABLE 1

| | | | | | | Per- | | Torque |
|---|---|---|---|---|---|---|---|---|
| | | | | | | cent | Volts/ | Constant |
| | Rotor | Test | | | | Rip- | Radian/ | (oz- |
| FIG. | Type | rpm | V_{MAX} | V_{MIN} | V_{RMS} | ple | Second | in/Amp) |
| 6A | DMC | 1200 | 4.406 | 3.352 | 4.126 | 13.6 | .0328 | 4.649 |
| 6B | Non- | 1200 | 4.104 | 3.126 | 3.858 | 13.6 | .0307 | 4.347 |
| | DMC | | | | | | | |
| 6C | Non- | 1200 | 4.088 | 3.189 | 3.868 | 12.4 | .0308 | 4.358 |
| | DMC | | | | | | | |

The average torque constant for the two exemplary non-DMC rotors (FIGS. 6B and 6C) is 4.3525 oz-in/Amp; therefore, the DMC rotor of FIG. 5A has ((4.649/4.3525)−1)×100=6.8% greater torque constant than the average torque constant of the two non-DMC rotors.

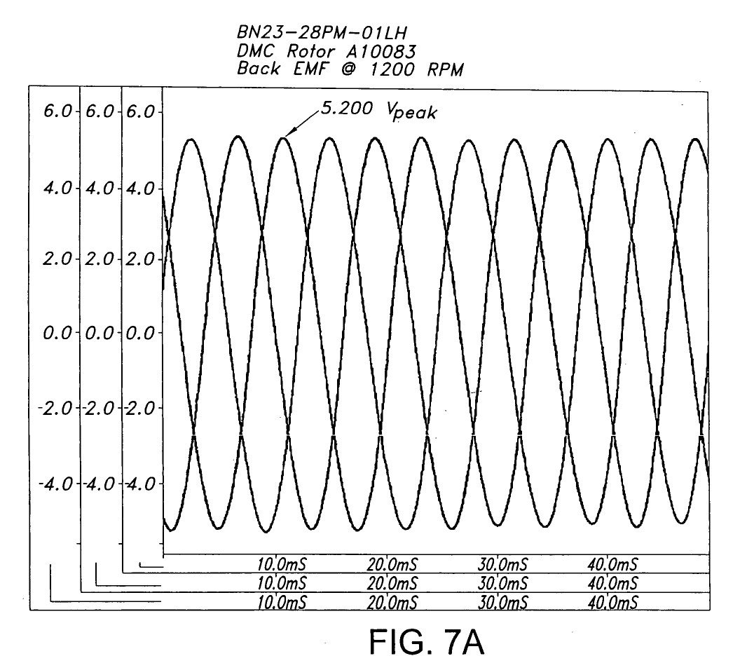

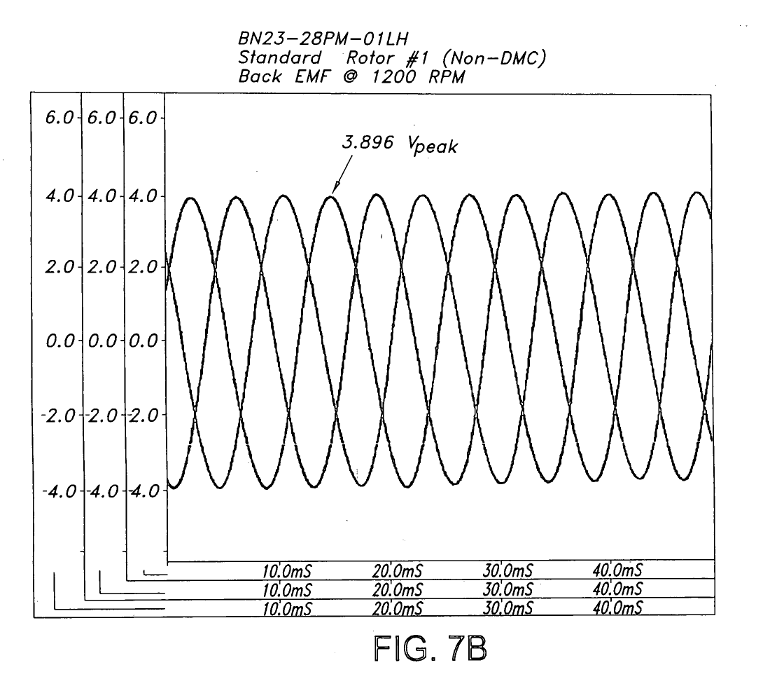

Furthermore, a rotor 106 produced by the DMC techniques and utilizing exchange spring nano-powder neodymium as the powder material for the permanent magnet (not shown) exhibits from 18 to 33.5 percent greater magnetic flux density than a rotor 106 produced by compression molding of an isotropic neodymium powder for its permanent magnet. FIGS. 7A and 7B provide exemplary illustration of the improved performance of a rotor produced by DMC techniques utilizing exchange spring nano-powder neodymium. FIG. 7A is an exemplary plot of the back EMF produced by a rotor of one embodiment of the present invention produced by DMC techniques utilizing the exchange spring powder for its permanent magnet. FIG. 7B is an exemplary plot of the back EMF produced by rotors where the permanent magnet is formed of isotropic neodymium powder using compression molding techniques, rather than by DMC. As can be seen by comparing FIGS. 7A and 7B, the back EMF of the exchange spring DMC rotor (FIG. 7A) is 5.200 volts peak, whereas the back EMF of the non-DMC rotor is 3.896 volts peak. Peak voltage is directly proportional to flux density, which is directly proportional to torque constant. Therefore, the exchange spring DMC rotor (FIG. 7A) has ((5.200/3.896)−1)×100=33.47 percent increase in torque constant over the non-DMC rotor of FIG. 7B. These rotors were tested under similar circumstances and at the same rpm (1200 rpm).

Although the described inventive concepts disclose a rotor formed by compacting powdered permanent magnet material and, in some instances, powdered core material substantially about a relatively incompressible shaft, the same concepts can apply to other electromechanical and non-electrical devices for attachment to a shaft. For instance, the above invention is equally applicable to shaft-mounted devices such as, for example, gears, cams, cogs, tool heads and bodies, blades, flywheels where such devices may be compacted directly to the shaft by DMC. For example, a flywheel may be formed substantially about a non-insulated shaft by placing the shaft in a die that holds it in place substantially through a flywheel mold. The flywheel mold having deformable conductive sides or at least conductive sides that may mechanically move inwardly (toward the non-insulated shaft) when exposed to the magnetic field of the DMC process. Placing a suitable powdered material within the mold and exposing the mold (and the powdered material therein) to a DMC process such that the sides of the mold are compressed radially inward toward the shaft thereby forming a solid of the powdered material with said solid substantially in the desired shape.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1-47. (canceled)

48. A d.c. brushless motor, comprising:
a stator; and
a rotor;
said rotor having a shaft, a core compacted about said shaft and a magnet compacted about said core;
said motor having a torque constant from 6.8% to 33.47% greater that the torque constant of an identically-dimensioned motor having a core formed of solid 12L14 steel.

49. A d.c. brushless motor as set forth in claim 48 wherein said core and magnet are compacted simultaneously.

50. A d.c. brushless motor as set forth in claim 48 wherein said core is first compacted about said shaft, and said magnet is subsequently compacted about said core.

51. A d.c. brushless motor as set forth in claim 48 wherein said core is compacted from soft iron powder.

52. A d.c. brushless motor as set forth in claim 48 wherein said magnet is compacted from isotropic neodymium powder or anisotropic neodymium and exchange spring nano-powder neodymium.

53. A d.c. brushless motor, comprising:
a stator; and
a rotor;
said rotor having a shaft, a core of exchange spring nano-powder neodymium compacted about said shaft and a magnet compacted about said core;
said rotor having a magnetic flux density of from 18% to 33.5% greater than the magnetic flux density of an identical rotor produced by compression molding an isotropic neodymium powder for its magnet.
